(19) United States
(12) Patent Application Publication
(10) Pub. No.: US 2015/0007145 A1
(43) Pub. Date: Jan. 1, 2015

(54) COMPUTING SYSTEM WITH INSTRUMENTATION MECHANISM AND CAPTURE MECHANISM AND METHOD OF OPERATION THEREOF

(71) Applicant: Samsung Electronics Co., Ltd., Gyeonggi-do (KR)

(72) Inventors: Jeffrey Scott Pierce, Sunnyvale, CA (US); Esther Jun Kim, San Jose, CA (US); Alan John Walendowski, San Jose, CA (US)

(21) Appl. No.: 13/932,571

(22) Filed: Jul. 1, 2013

(51) Int. Cl. G06F 11/34

(52) U.S. Cl. CPC G06F 11/3466
USPC 717/130

(57) ABSTRACT

A computing system includes: an input module configured to receive an application code; an identification module, coupled to the input module, configured to identify an interface element in the application code; and an insertion module, coupled to the identification module, configured to insert an augmentation code into the application code for modifying an attribute of the interface element.

### TECHNICAL FIELD

An embodiment of the present invention relates generally to a computing system, and more particularly to a system for instrumentation and capture.

### BACKGROUND

Modern consumer and industrial electronics, such as computing systems, televisions, projectors, cellular phones, portable digital assistants, and combination devices, are providing increasing levels of functionality to support modern life. In addition to the explosion of functionality and proliferation of these devices into the everyday life, there is also an explosion of data and information being created, transported, consumed, and stored.

The explosion of data and information comes from different applications, e.g. social networks, electronic mail, web searches, and in different forms, e.g. text, sounds, images. The myriad of applications can also generate much of the data on its own. Research and development for handling this dynamic mass of data can take a myriad of different directions.

Thus, a need still remains for a computing system with instrumentation mechanism and capture mechanism for effectively addressing the various applications' effectiveness. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a computing system, including: an input module configured to receive an application code; an identification module, coupled to the input module, configured to identify an interface element in the application code; and an insertion module, coupled to the identification module, configured to insert an augmentation code into the application code for modifying an attribute of the interface element.

An embodiment of the present invention provides a method of operation of a computing system including: receiving an application code; identifying an interface element in the application code with a control unit; and inserting an augmentation code into the application code for modifying an attribute of the interface element.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with instrumentation and capture mechanism in an embodiment of the present invention.

FIG. 2 is an example display of a first example for the application on the first device.

FIG. 3 is an example display of a second example for the application on the first device.

FIG. 4 is the display of FIG. 2 with instrumentations.

FIG. 5 is the display of FIG. 3 with the instrumentations.

FIG. 6 is an exemplary display of a report for an execution of the application with the instrumentations.

FIG. 7 is an exemplary block diagram of the computing system.

FIG. 8 is a control flow of the computing system.

FIG. 9 is a flow chart of a method of operation of a computing system in a further embodiment of the present invention.

### DETAILED DESCRIPTION

An embodiment of the present invention provides a method and system configured to run an application's code in a computing system. The system's identification module detects instrumentation points within the application and the capture module provides feedback about how the application is instrumented during execution of the application. As examples, this feedback can include visually distinguishing interface controls that capture interactions (e.g., coloring buttons that capture clicks a different color than buttons that do not) and playing audio cues when the application actually captures data (e.g., playing a particular tone with the application captures the user switching to a new view, while playing a different tone when the application captures the user interacting with an interface component within a view).

An embodiment of the present invention provides a method and system configured to execute application code with added instrumentation code while the capture module can also detect, reformat, and present logged data to the tester. As an example, the instrumentation data, which is logged, can be sent to the second device, such as a server, from the first device, such as a client device, over a communication path, such as a cellular network. The instrumentation data communicated over the communication path to the second device is typically invisible to developers/testers, requiring extra work to inspect. The computing system can automatically perform the extra work to detect, format, and display sent logged information. If the data is sent to a member of a known set of analytics providers the tool could additionally take advantage of known data formatting conventions for each provider by formatting the captured information before displaying it in order to make it even easier for testers to understand what information is actually being logged.

An embodiment of the present invention provides a method and system configured to simplify and improve verification of the instrumentation of an application because the capture module can generate a data capture specification it believes the application meets based on the a priori and runtime detected instrumentation.

An embodiment of the present invention provides a method and system configured to further simplify and improve verification of the application because the capture module can compare the capture specification, as the original data capture specification, with the encountered data capture specification (based on inspection of the application code with the identification module and observation of the user's interaction with the application) that testers could compare to the original data capture specification. If the capture specification is in a well-known format and the application is using an analytics software development kit (SDK) with known characteristics, the capture module can further verify whether the application possesses the desired instrumentation. The capture module can then generate the report or modified data capture specification indicating where it found the desired instrumentation (potentially including mappings between desired instrumentation and likely corresponding location in the code), where it expected to find instrumentation but did not, and where it found instrumentation it did not expect. These disconnects are potential instrumentation errors. In other words, the capture module can identify instrumentation errors that are omissions or additions.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

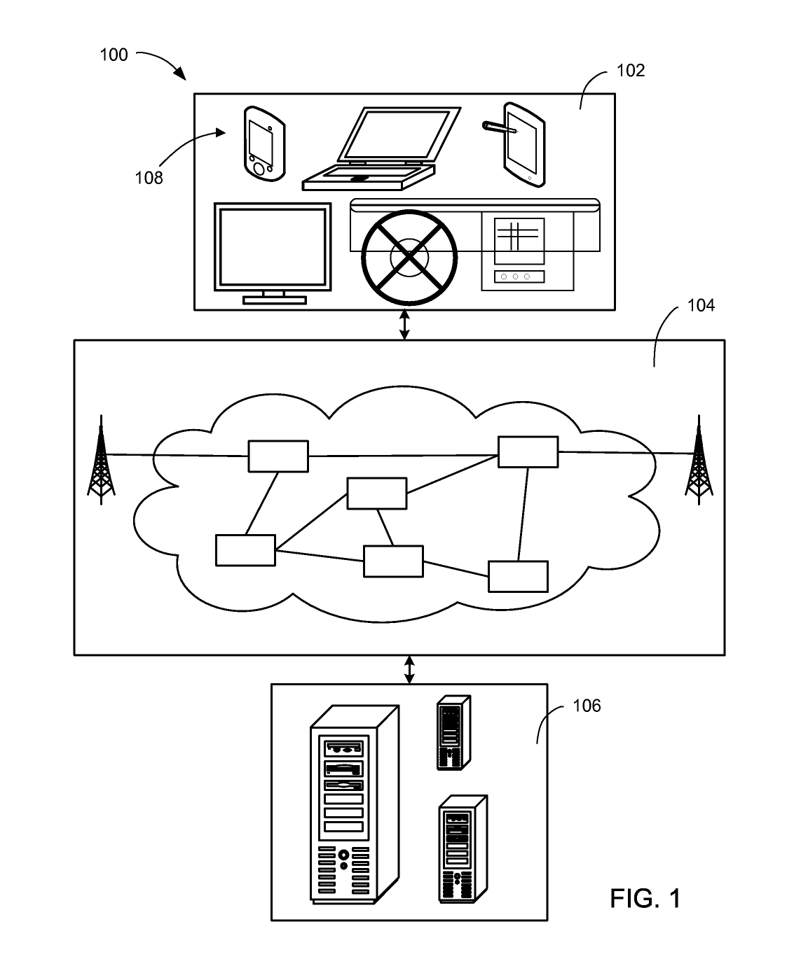

Referring now to FIG. 1, therein is shown a computing system 100 with instrumentation and capture mechanism in an embodiment of the present invention. The computing system 100 includes a first device 102, such as a client or a server, connected to a second device 106, such as a client or server. The first device 102 can communicate with the second device 106 with a communication path 104, such as a wireless or wired network.

Users of the first device 102, the second device 106, or a combination thereof can access or create information including text, images, symbols, location information, and audio, as examples. The users can be individuals or enterprise companies.

In the connected world, an application 108 can be executed for information creation, transmission, storage, or a combination thereof. The application 108 is a software for performing a function. The application 108 can be executed on the first device 102, the second device 106, or a combination thereof. The application 108 can be viewed on the first device 102, the second device 106, or a combination thereof.

As an example, the application 108 executing on the first device 102 can be different than the version being executed on the second device 106 or distributed between these devices. For brevity and clarity, the application 108 will be described as the same regardless of where it is executed, although there can be differences in the versions running on different hardware and software platforms.

Returning to the description of the computing system 100, the first device 102 can be of any of a variety of devices, such as a smartphone, a cellular phone, personal digital assistant, a tablet computer, a notebook computer, a multi-functional display or entertainment device, or an automotive telematics system. The first device 102 can couple, either directly or indirectly, to the communication path 104 to communicate with the second device 106 or can be a stand-alone device.

The second device 106 can be any of a variety of centralized or decentralized computing devices, or transmission devices. For example, the second device 106 can be a laptop computer, a desktop computer, grid-computing resources, a virtualized computer resource, cloud computing resource, routers, switches, peer-to-peer distributed computing devices, or a combination thereof.

The second device 106 can be centralized in a single room, distributed across different rooms, distributed across different geographical locations, or embedded within a telecommunications network. The second device 106 can couple with the communication path 104 to communicate with the first device 102.

For illustrative purposes, the computing system 100 is described with the second device 106 as a computing device, although it is understood that the second device 106 can be a different type of device. Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

The communication path 104 can span and represent a variety of network types and network topologies. For example, the communication path 104 can include wireless communication, wired communication, optical communication, ultrasonic communication, or a combination thereof. Satellite communication, cellular communication, Bluetooth, Infrared Data Association standard (lrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

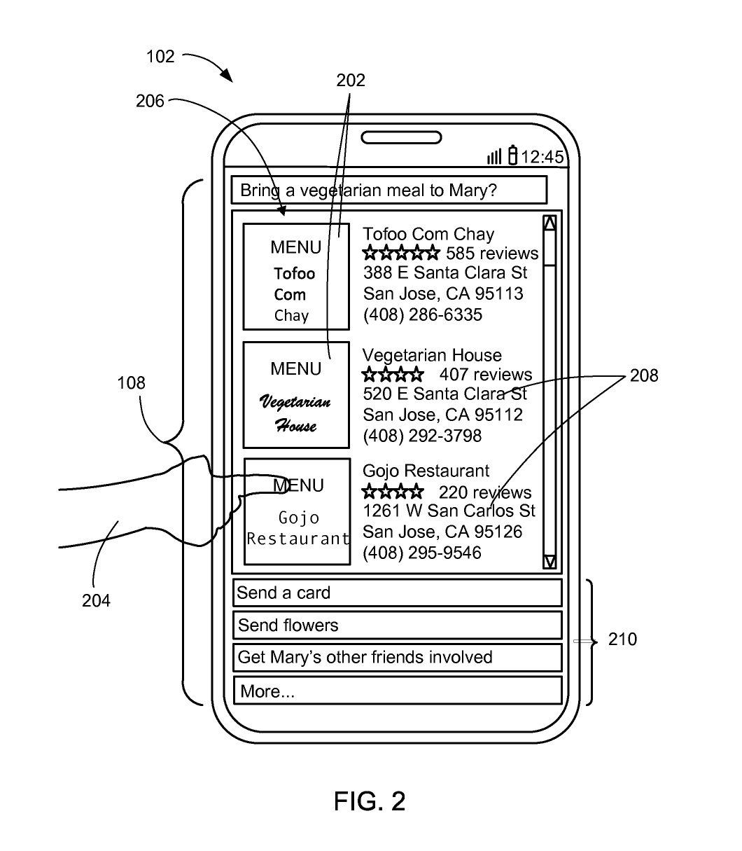

Referring now to FIG. 2, therein is shown an example display of an exemplary application 108 on the first device 102. In this example, the first device 102 is depicted as a mobile device, such as a smartphone or a computer tablet, and the application 108 is depicted as an application including information about a restaurant.

The application 108 can include a number of interface elements 202. The interface elements 202 are action items for a user's interaction 204 with the application 108. In this example, the interface elements 202 are information icons 206, actionable text 208, and function icons 210.

The information icons 206 provide additional information regarding a current view or display of the application. In this example, the information icons 206 are for menu information for the restaurant being displayed.

The actionable text 208 is text that can provide a functional response by the application 108 when invoked or pressed or activated but not displayed as an icon. As an example, the actionable text 208 can be a hyperlinked texted for the address of the restaurant.

The function icons 210 are icons displayed by the application 108 for invoking a function that is different than the main function being displayed. In this example, the main function being displayed by the application 108 is a restaurant listing with ratings and other information regarding the individual restaurants. The function icons 210 can be the tabs for “Send a card”, “Send flowers”, or “More . . . ”.

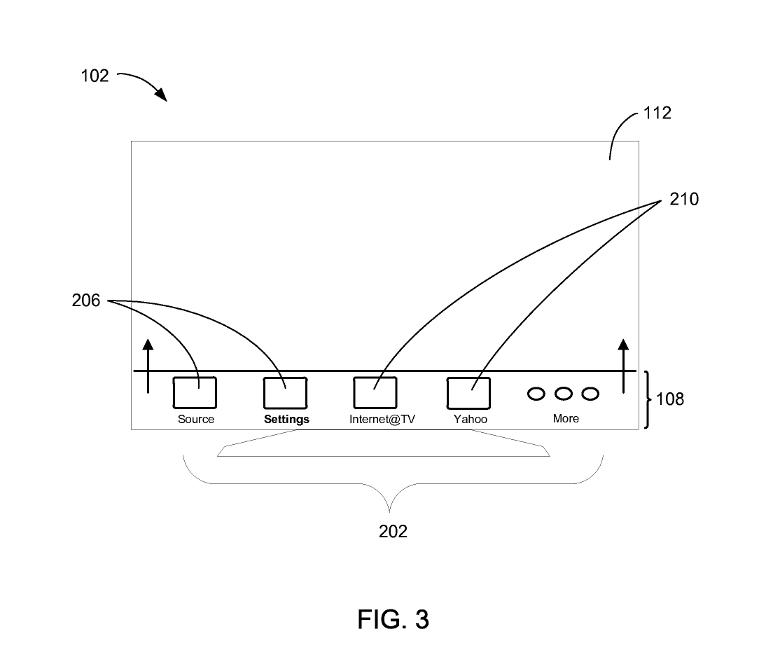

Referring now to FIG. 3, therein is shown an example display of a second example for the application 108 on the first device 102. In this example, the first device 102 is depicted as a television and the application 108 is depicted as a control for the television.

Similar to the description in FIG. 2, the application 108 in this example can also include the interface elements 202 for the information icons 206, the actionable text 208 of FIG. 2, and the function icons 210. This particular example does not depict the actionable text 208.

FIG. 3 depicts the example of the main function for the application 108 to operate a smart television. This includes the application 108 providing the information icons 206, such as “Source” and “Settings”. The application 108 can also provide the function icons 210, such as Internet@TV” or “Yahoo” or “More”. The application 108 can also provide the interface elements 202 without any text, such as the line in FIG. 3 for revealing or hiding the display of the interface elements 202.

As shown with FIG. 2 and FIG. 3, the interface elements 202 for the application 108 can provide different types of functions or they can provide the same type of functions. Also, the interface elements 202 can look the same, as most of them in FIG. 3, or can look very different as more apparent in FIG. 2.

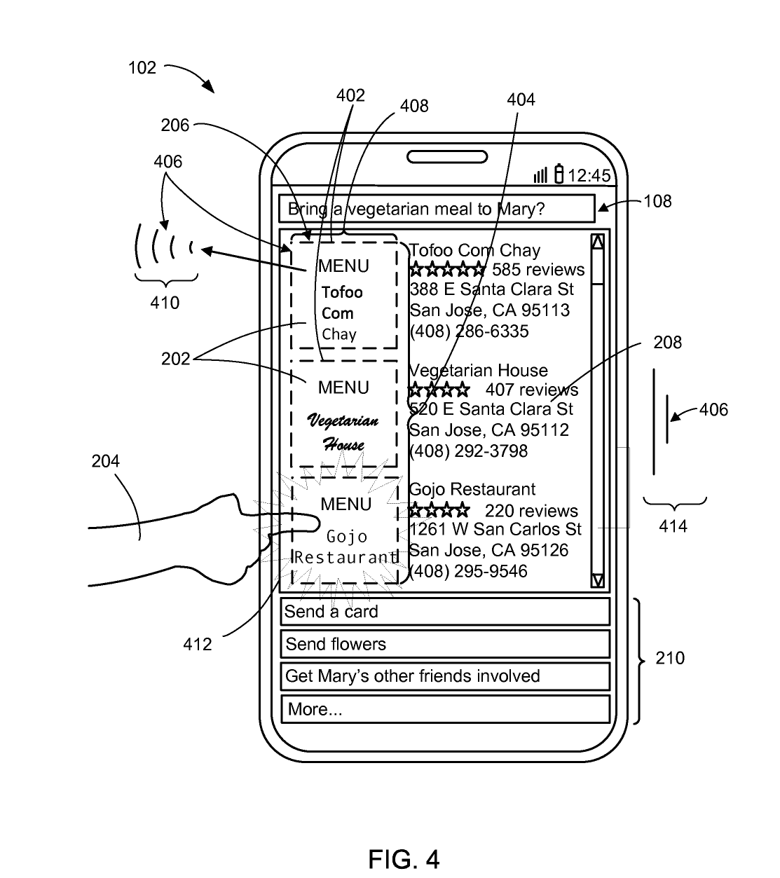

Referring now to FIG. 4, therein is shown the display of FIG. 2 with instrumentations 402. The instrumentations 402 are portions in the application 108 that are being analyzed. In this example, the instrumentations 402 are some of the interface elements 202 for the application 108.

In the example in FIG. 4, FIG. 4 depicts an instrumentation coverage 404 for the interface elements 202 to cover the information icons 206 but not the actionable text 208 or the function icons 210. The instrumentation coverage 404 is a representation of what parts of the application 108 have been instrumented or the amount of the instrumentations 402 for the application 108.

The instrumentations 402 can be depicted by altering or modifying attributes 406 of the interface elements 202. The attributes 406 are visual, auditory, or tactile characteristics for each of the interface elements 202. In this example, the information icons 206 are shown with dashed lines indicated that these particular examples for the interface elements 202 have been instrumented. The dashed lines represent a change in a visual appearance 408 for the attributes 406 of the interface elements 202.

As the first device 102 executes the application 108, in this example, the user's interaction 204 with the instrumentations 402 can invoke a modification to the attributes 406 to provide audio cues 410, visual cues 412, tactile cues 414, or a combination thereof. The audio cues 410 provide audio notification if a particular instance of the interface elements 202, which has been instrumented, has been invoked. The visual cues 412 provide visual notification if a particular instance of the interface elements 202, which has been instrumented, has been invoked. The tactile cues 414 provide tactile notification if a particular instance of the interface elements 202, which has been instrumented, has been invoked.

As examples, the audio cues 410 can include a sound pattern or a beep. The visual cues 412 can include blinking action or a changing of colors of the interface elements 202. The tactile cues 414 can include a vibration of the first device 102 or upon a stylus (not shown) used for invoking the action on the first device 102.

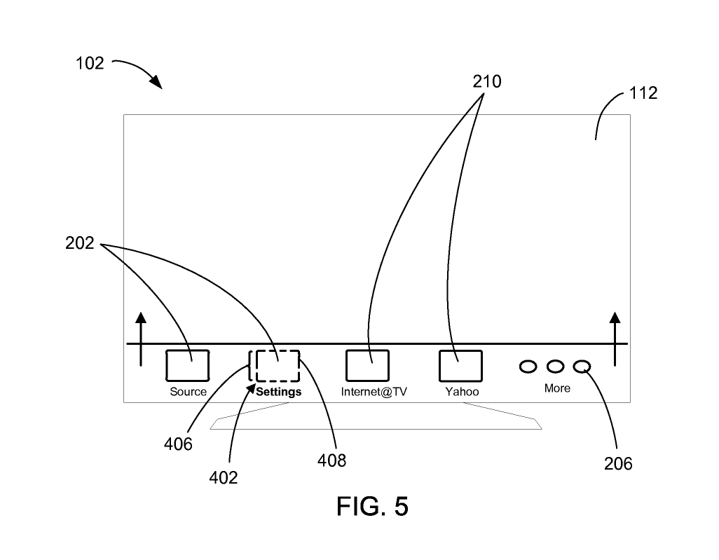

Referring now to FIG. 5, therein is shown the display of FIG. 3 with the instrumentations 402. In this example, some of the information icons 206 are shown with dashed lines indicated that these particular examples for the interface elements 202 have been instrumented. The dashed lines represent a change in the visual appearance 408 for the attributes 406 of the interface elements 202.

The “Settings” icon for the information icons 206 is shown as instrumented. The “Source” icon for the information icons 206 is shown as not instrumented and depicted with a solid outlines as in FIG. 3 as opposed to the dashed outline for the icon. This example also depicts the function icons 210, such as Internet@TV” or “Yahoo” or “More” as not being instrumented and depicted with a solid outline for the icon. The line example for the interface elements 202 is also shown as not instrumented and depicted with as solid line as in FIG. 3.

For illustrative purposes, the examples of the instrumentations 402 in FIG. 4 and FIG. 5 are described as those selections of the interface elements 202 having the attributes 406 being reflected as modified and not modifying the attributes 406 for the interface elements 202 not being instrumented. However, the computing system 100 can also modify the attributes 406 of the interface elements 202 not being instrumented, analyzed, or verified to emphasize which of the interface elements 202 is not being verified. The attributes 406 for the non-tested selections of the interface elements 202 can be reflected differently than those being instrumented. For example, the attributes 406 can be for a different color or pattern or animation, tone, or tactile response.

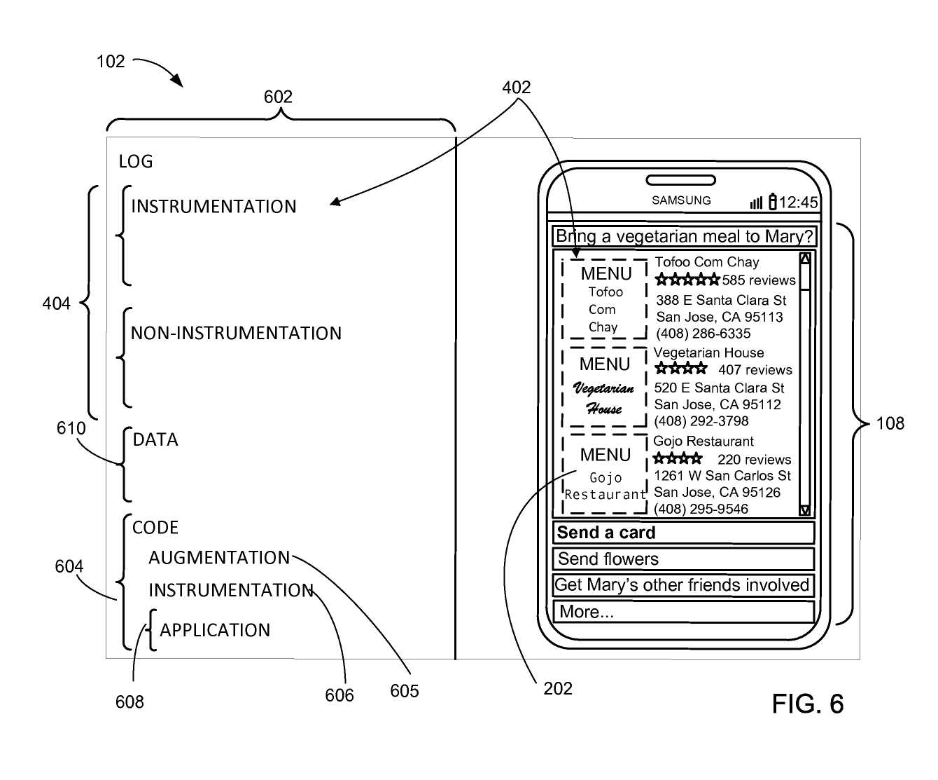

Referring now to FIG. 6, therein is shown an exemplary display of a report 602 for an execution of the application 108 with the instrumentations 402. In this example, the application 108 from FIG. 4 is depicted with the instrumentations 402 on the right hand side of the figure. On the left hand side of the figure, the report 602 is shown for the execution of the application 108 having the instrumentations 402 inserted.

The report 602 depicts an application code 604 for the application 108. The application code 604 is a representation for the operational steps for the application 108. As examples, the representation can be in text, with network graph of the steps and relationships, with icons, or a combination thereof. The application code 604 can represent the software instructions for the application 108 or can be the steps executed by a hardware implementation of the application 108.

The report 602 also depicts an augmentation code 605 and an instrumentation code 606 for the instrumentations 402. The augmentation code 605 is code that the embodiment of the present invention inserts to modify the attributes 406 of FIG. 4. The instrumentation code 606 is code added to the application code 604 to implement the desired data capture specification. As a more specific example, the instrumentation code 606 is the code for collecting data about how the user interacts with the application 108 of FIG. 1 and logs data.

In this example, both the augmentation code 605 and the instrumentation code 606 are shown before a handler 608 for a particular instance of the interface elements 202. The handler 608 is part of the application code 604 for the interface elements 202. The report 602 can also provide the instrumentation coverage 404 for the application 108 being tested.

For illustrative purposes, the augmentation code 605 and the instrumentation code 606 are shown above the handler 608, although it is understood that the augmentation code 605 and the instrumentation code 606 can be in a different configuration. For example, the augmentation code 605, the instrumentation code 606, or a combination thereof can be inserted after the handler 608 or both before and after the handler 608 depending on the functionality being performed by the instrumentations 402 for a particular instance of the interface elements 202. Also for example, the augmentation code 605, the instrumentation code 606, or a combination thereof can interact with the handler 608 and the interactions are inserted before, after, or a combination thereof to the handler 608. This interaction model does not require the augmentation code 605, the instrumentation code 606, or a combination thereof to be actually inserted into the application code 604 but rather the augmentation code 605, the instrumentation code 606, or a combination thereof can interact with the application code 604 or more specifically the handler 608 based on information exchange from the application code 604 and to the handler 608 as the application 108 executes.

The report 602 also depicts instrumentation data 610 for the particular instance of the interface elements 202 being tested or examined with the instrumentations 402 and the instrumentation code 606. The instrumentation data 610 are information gathered for the application 108 being tested with the embodiment of the present invention.

The instrumentation data 610 can include data captured from the user's interaction 204 of FIG. 2 with different parts of the interface elements 202, including sample data capture after completing one or more interaction session with the application 108. The instrumentation data 610 can include not only debug information, network traffic, or a combination thereof but also structure the logged data packages and reformat them for use for additional test software or by a tester.

The instrumentation data 610 can be tied to the execution of the application 108 as depicted on the right-hand-side of FIG. 6. The instrumentation data 610, as well as other portions of the report 602, can vary depending on the state of execution of the application code 604. The application code 604 can be executed in step-by-step mode executing one instruction in the application code 604 at a time or in normal mode. The application code 604 can always be executed in a reverse mode to an execution state in a prior instruction or step. The instrumentation data 610 as well as other portions of the report 602 can vary depending on the execution state of the application 108 in any of the modes noted above.

The report 602 can include a list of the interface elements 202 that are available to be instrumented, a list of the interface elements 202 that have been instrumented, and a list of the interface elements 202 that have not been instrumented. The report 602 can also include a list of instrumentation methods, such as including links to those methods in the application code 604 or to the instrumentation code 606.

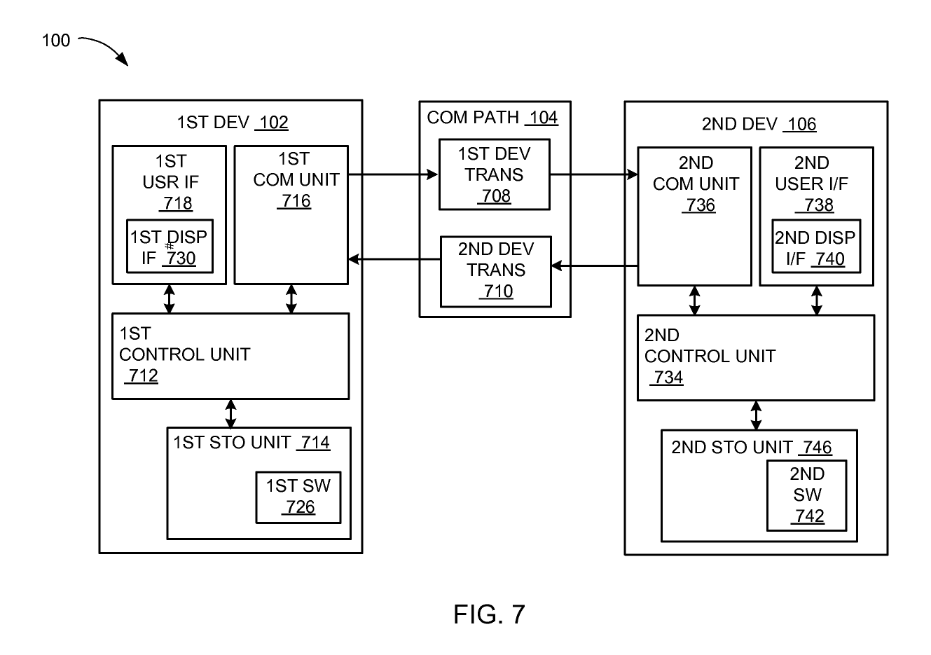

Referring now to FIG. 7, therein is shown an exemplary block diagram of the computing system 100. The computing system 100 can include the first device 102, the communication path 104, and the second device 106. The first device 102 can send information in a first device transmission 708 over the communication path 104 to the second device 106. The second device 106 can send information in a second device transmission 710 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

The first device 102 can include a first control unit 712, a first storage unit 714, a first communication unit 716, and a first user interface 718. The first control unit 712 can execute a first software 726 to provide the intelligence of the computing system 100.

The first control unit 712 can be implemented in a number of different manners. For example, the first control unit 712 can be a processor, an application specific integrated circuit (ASIC), an embedded processor, a microprocessor, a hardware control logic, a hardware finite state machine (FSM), a digital signal processor (DSP), or a combination thereof. The first control unit 712 can communicate with other functional units in and external to the first device 102. The external sources and the external destinations refer to sources and destinations external to the first device 102.

The first storage unit 714 can store the first software 726. The first storage unit 714 can also store the relevant information, such as the application code 604 of FIG. 6, the augmentation code 605 of FIG. 6, the instrumentation code 606 of FIG. 6, the report 602 of FIG. 6, or a combination thereof.

The first storage unit 714 can be a volatile memory, a nonvolatile memory, an internal memory, an external memory, or a combination thereof. For example, the first storage unit 714 can be a nonvolatile storage such as non-volatile random access memory (NVRAM), Flash memory, disk storage, or a volatile storage such as static random access memory (SRAM). The first storage unit 714 can communicate between and other functional units in or external to the first device 102.

The first communication unit 716 can enable external communication to and from the first device 102. For example, the first communication unit 716 can permit the first device 102 to communicate with the second device 106 of FIG. 1, an attachment, such as a peripheral device or a computer desktop, and the communication path 104.

The first communication unit 716 can also function as a communication hub allowing the first device 102 to function as part of the communication path 104 and not limited to be an end point or terminal unit to the communication path 104. The first communication unit 716 can include active and passive components, such as microelectronics or an antenna, for interaction with the communication path 104. The first communication unit 716 can communicate with other functional units in and external to the first device 102.

The first user interface 718 allows a user (not shown) to interface and interact with the first device 102. The first user interface 718 can include an input device and an output device. Examples of the input device of the first user interface 718 can include a keypad, a touchpad, soft-keys, a keyboard, a microphone, an infrared sensor for receiving remote signals, or any combination thereof to provide data and communication inputs.

The first user interface 718 can include a first display interface 730. The first display interface 730 can include a display, a projector, a video screen, a speaker, or any combination thereof.

The first control unit 712 can operate the first user interface 718 to display information generated by the computing system 100. The first control unit 712 can also execute the first software 726 for the other functions of the computing system 100. The first control unit 712 can further execute the first software 726 for interaction with the communication path 104 via the first communication unit 716.

The second device 106 can be optimized for implementing an embodiment of the present invention in a multiple device embodiment with the first device 102. The second device 106 can provide the additional or higher performance processing power compared to the first device 102. The second device 106 can include a second control unit 734, a second communication unit 736, and a second user interface 738.

The second user interface 738 allows a user (not shown) to interface and interact with the second device 106. The second user interface 738 can include an input device and an output device. Examples of the input device of the second user interface 738 can include a keypad, a touchpad, soft-keys, a keyboard, a microphone, or any combination thereof to provide data and communication inputs. Examples of the output device of the second user interface 738 can include a second display interface 740. The second display interface 740 can include a display, a projector, a video screen, a speaker, or any combination thereof.

The second control unit 734 can execute a second software 742 to provide the intelligence of the second device 106 of the computing system 100. The second software 742 can operate in conjunction with the first software 726. The second control unit 734 can provide additional performance compared to the first control unit 712.

The second control unit 734 can operate the second user interface 738 to display information. The second control unit 734 can also execute the second software 742 for the other functions of the computing system 100, including operating the second communication unit 736 to communicate with the first device 102 over the communication path 104.

The second control unit 734 can be implemented in a number of different manners. For example, the second control unit 734 can be a processor, an embedded processor, a microprocessor, hardware control logic, a hardware finite state machine (FSM), a digital signal processor (DSP), or a combination thereof. The second control unit 734 can communicate with other functional units in and external to the second device 106.

A second storage unit 746 can store the second software 742. The second storage unit 746 can also store the information, such as data representing the information discussed in FIG. 6. The second storage unit 746 can be sized to provide the additional storage capacity to supplement the first storage unit 714.

For illustrative purposes, the second storage unit 746 is shown as a single element, although it is understood that the second storage unit 746 can be a distribution of storage elements. Also for illustrative purposes, the computing system 100 is shown with the second storage unit 746 as a single hierarchy storage system, although it is understood that the computing system 100 can have the second storage unit 746 in a different configuration. For example, the second storage unit 746 can be formed with different storage technologies forming a memory hierarchal system including different levels of caching, main memory, rotating media, or off-line storage.

The second storage unit 746 can be a volatile memory, a nonvolatile memory, an internal memory, an external memory, or a combination thereof. For example, the second storage unit 746 can be a nonvolatile storage such as non-volatile random access memory (NVRAM), Flash memory, disk storage, or a volatile storage such as static random access memory (SRAM). The second storage unit 746 can communicate with other functional units in or external to the second device 106.

The second communication unit 736 can enable external communication to and from the second device 106. For example, the second communication unit 736 can permit the second device 106 to communicate with the first device 102 over the communication path 104.

The second communication unit 736 can also function as a communication hub allowing the second device 106 to function as part of the communication path 104 and not limited to be an end point or terminal unit to the communication path 104. The second communication unit 736 can include active and passive components, such as microelectronics or an antenna, for interaction with the communication path 104. The second communication unit 736 can communicate with other functional units in and external to the second device 106.

The first communication unit 716 can couple with the communication path 104 to send information to the second device 106 in the first device transmission 708. The second device 106 can receive information in the second communication unit 736 from the first device transmission 708 of the communication path 104.

The second communication unit 736 can couple with the communication path 104 to send information to the first device 102 in the second device transmission 710. The first device 102 can receive information in the first communication unit 716 from the second device transmission 710 of the communication path 104. The computing system 100 can be executed by the first control unit 712, the second control unit 734, or a combination thereof. For illustrative purposes, the second device 106 is shown with the partition having the second user interface 738, the second storage unit 746, the second control unit 734, and the second communication unit 736, although it is understood that the second device 106 can have a different partition. For example, the second software 742 can be partitioned differently such that some or all of its function can be in the second control unit 734 and the second communication unit 736. Also, the second device 106 can include other functional units not shown in FIG. 7 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100.

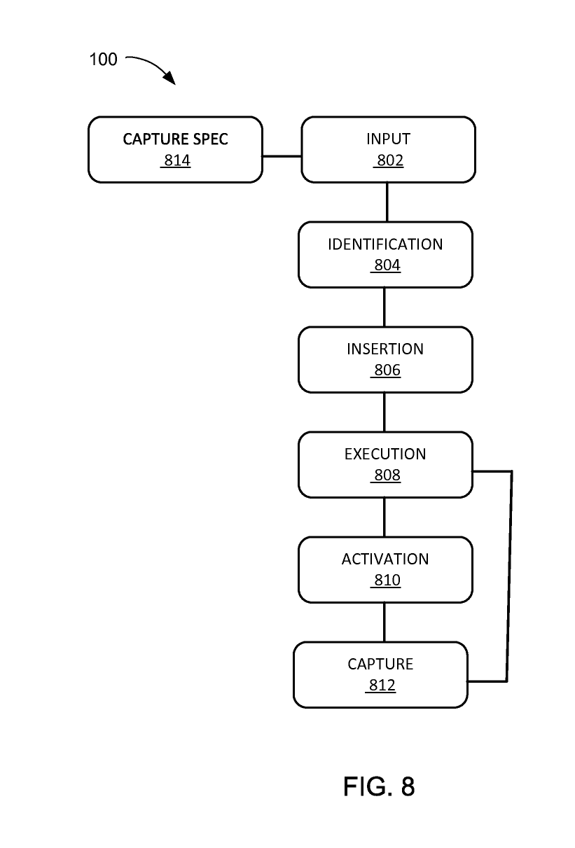

Referring now to FIG. 8, therein is shown a control flow of the computing system 100. The control flow can include an input module 802, an identification module 804, an insertion module 806, an execution module 808, an activation module 810, and a capture module 812. The computing system 100 can also include a capture specification 814.

The capture specification 814 provides target test information for the application 108 being tested. For example, the capture specification 814 can include the interface elements 202 of FIG. 2 that should have the instrumentations 402. The capture specification 814 can also include the instrumentation coverage 404 of FIG. 4 for the application 108. The capture specification 814 can further include the expected types or values for the instrumentation data 610 being captured.

The order of operation of the control flow can be as shown in the figure or as described in this application. The order of operation is exemplary as is the partition of the modules. The control flow can operate in a different configuration or order, such as not linear and can include loop backs or iterations.

The input module 802 functions to receive information or data for the embodiment of the present invention. As an example, the input module 802 can receive the application code 604 of FIG. 6 for the application 108 of FIG. 6 being tested. If available or desired, the input module 802 can also receive the capture specification 814. The flow can progress from the input module 802 to the identification module 804.

The identification module 804 identifies portions of the application code 604 for instrumentation. The instrumentation also refers to the augmentation for the attributes 406 of FIG. 4. The identification module 804 can identify locations in the application code 604 for instrumentation in a number of ways. For example, the identification module 804 can detect initial instrumentation points by scanning the application code 604 and identifying calls or the handler 608 to methods from the software development kits (SDKs) of known analytics providers. The identification module 804 can perform the scan and identification by parsing the application code 604 and identifying the handler 608.

The identification module 804 or the present embodiment of the present invention can be extensible to new SDKs by providing it with a list of methods annotated with relevant properties. The identification module 804 further can use information about the structure of user interface code in the application code 604 to determine which of the interface elements 202 are being instrumented. For example, the tool can identify the instrumented points as follows:
If the capture specification 814 is provided and includes a list of methods to call for logging, the tool can use this information directly to scan for and locate instrumentation points within the application code 604.
If a list of methods is not supplied, the identification module 804 can check the structure of the application code 604 against known analytics SDKs to identify the instrumented points.

Examples of the interface elements 202 and the application 108 being processed by the identification module 804 and the computing system 100 is depicted in FIG. 2 and FIG. 3. The flow can progress from the identification module 804 to the insertion module 806.

The insertion module 806 inserts or injects the augmentation code 605 of FIG. 6 with the application code 604 for the instrumentations 402 at the instrumentation points. The instrumentation points can be identified by the identification module 804 or can be extracted from the capture specification 814 or can be manually entered.

The insertion module 806 can insert the augmentation code 605 for the instrumentations 402. The instrumentation code 606 can be within the handler 608 for each of the interface elements 202 so that logging occurs before, during, after, or a combination thereof the user's interaction 204 with a particular instance of the interface elements 202 as a user interface (UI) control. As an example, once the identification module 804 has determined where the augmentation points are located within the application code 604, the insertion module 806 can check the application code 604 to determine which of the handler 608 contains the augmentation point and, by tracing the assignment of the handler 608 to the creation of the element, which of the interface elements 202 is augmented and how. The flow can progress from the insertion module 806 to the execution module 808.

The insertion module 806 can insert the augmentation code 605 into the application code 604 for modifying one or more of the attributes 406 of FIG. 4 of the interface elements 202. As examples, the modification of the attributes 406 can be shown in FIG. 4 and in FIG. 5. As described earlier, the insertion module 806 can modify the attributes 406 for the visual appearance 408, or modify or insert the visual cues 412 of FIG. 4, the audio cues 410 of FIG. 4, the tactile cues 414 of FIG. 4, or a combination thereof.

The execution module 808 executes or operates the application code 604 having the instrumentations 402. As a more specific example, the execution module 808 executes the application code 604 with the augmentation code 605, the instrumentation code 606, or a combination thereof. The execution module 808 can aide to provide a display as depicted in FIG. 6. The flow can progress from the execution module 808 to the activation module 810.

The activation module 810 activates or executes the augmentation code 605 associated with the instrumentation code 606. The activation module 810 invokes the attributes 406 as part of the augmentation code 605 inserted with the application code 604. If the modification of the attributes 406 warrants a change in the visual appearance 408 of the interface elements 202, the activation module 810 can change the visual appearance 408 as depicted and described in FIG. 4 and FIG. 5. The visual appearance 408 can be changed after the insertion module 806, with or without actual execution of the application code 604 with the execution module 808

In the example where the execution module 808 executes the application code 604 and the augmentation code 605, the activation module 810 can activate the augmentation code 605 for the handler 608 of the interface elements 202 and invoke the respective cues as the visual cues 412, the audio cues 410, the tactile cues 414, or a combination thereof. The flow can progress from the activation module 810 to the capture module 812.

The capture module 812 generates the report 602 of FIG. 6. The capture module 812 can generate the report 602 for the instrumentation coverage 404, the instrumentation error 816, or a combination thereof based on the execution of the application code 604 with the instrumentation code 606. The capture module 812 can also generate the report 602 for the user's interaction 204 with the interface elements 202 based on the execution of the application code 604.

The execution module 808 can execute the application code 604 in an environment where the computing system 100 can directly inspect the user's interaction 204 and the resulting application responses. The insertion module 806 can modify the visual presentation of the interface elements 202 and provide additional cues based on application actions. This allows the computing system 100 to provide feedback about the application 108 by modifying the runtime appearance and behavior of the application 108 based on previously detected and runtime data capture actions.

Running the application code 604 in the computing system 100, the identification module 804 detects instrumentation points within the application 108 and the activation module 810 provides feedback about how the application 108 is instrumented during execution of the application 108. As examples, this feedback can include visually distinguishing interface controls that depict interactions (e.g., coloring buttons that capture clicks a different color than buttons that do not) and playing audio cues (e.g., playing a particular tone with the application captures the user switching to a new view, while playing a different tone with the application captures the user interacting with an interface component within a view) when the application actually captures data with the capture module 812. An alternative or complementary implementation might include a user interface (UI) widget library whose widgets have built-in support for instrumentation. These widgets could then be run in an ‘instrumentation verification mode’, which would cause them to change color or emit other cues when used.

As an example, the activation module 810 can provide the visual cues 412, the audio cues 410, the tactile cues 414, or a combination thereof in the following manner:
The activation module 810 when displaying an interface screen as depicted in FIG. 6 containing the instrumentations 402 for some of the interface elements 202 the computing system 100, which has previously identified the interface elements 202, with the identification module 804, can inject the augmentation code 605, with the insertion module 806, into the application 108 to change the attributes 406 of the interface elements 202 that have been instrumented by changing button colors or borders. In the example shown in FIG. 6, the borders are shown with dashed lines.
The capture module 812 can further provide the audio cues 410, the video cues 818, the tactile cues 414, or a combination thereof when the instrumentation data 610 of FIG. 6 is actually captured by injecting additional code around instrumentation points to play a sound or to display information in the interface. Since most interaction handlers (e.g., button click handlers) receive a pointer to the affected object the insertion module 806 can also inject the augmentation code 605 to further change the attributes 406 of that object (e.g., making it blink to indicate that the application 108 captured the interaction with it).

During execution of the application code 604 with the augmentation code 605, the capture module 812 can also detect, reformat, and present logged data to the tester. As an example, the instrumentation data 610 can be sent to the second device 106 of FIG. 7 from the first device 102 of FIG. 6 over the communication path 104 of FIG. 6. The instrumentation data 610 communicated over the communication path 104 to the second device 106 is typically invisible to developers/testers, requiring extra work to inspect. The computing system 100 can perform that extra work automatically to detect, format, and display sent captured information. If the data is sent to a member of a known set of analytics providers the tool could additionally take advantage of known data formatting conventions for that provider by formatting the captured information before displaying it in order to make it even easier for testers to understand what information is actually being logged.

As an example, the insertion module 806 can inject code around instrumentation points to copy the instrumentation data 610 that have been captured, reformat it for presentation to the user, and then display it to the user (for example, in a separate interface window that the computing system 100 opens with code injected into the application initialization routines) so that the tester understands how the information is logged and sent to the second device 106.

The capture module 812 can synthesize an instrumentation report or the report 602 that communicates the instrumentation and the instrumentation coverage 404 it detected both a priori and during execution of the application 108. The capture module 812 can synthesize the report 602 describing how the capture module 812 believes the application 108 is instrumented. The report 602 could combine information extracted by inspecting the application code 604 (particularly by detecting the handler 608 for the UI element code and the instrumentation code) with information gathered from user's interaction 204 with the application 108 while running in the computing system 100 as a verification tool.

Sample information the report could contain includes a list of the interface elements 202 that are instrumented, a list of the interface elements 202 that do not appear to be instrumented, a list of other instrumented methods (potentially including links to those methods in the code), textual or visual overviews of the instrumentation coverage 404 of the application 108 (a %, snapshots of the UI with instrumented and uninstrumented areas color coded, etc.), and samples of the instrumentation data 610 captured from the user's interaction 204 with different parts of the interface (after completing one or more interaction sessions with the application).

The capture module 812 can generate a data capture specification it believes the application 108 meets based on the a priori and runtime detected instrumentation, or if provided with the desired data capture specification, the capture specification 814, in a format the identification module 804 can parse and understand it could present the report 602 or a modified specification that conveys how and where it believes the application 108 does or does not meet the specification.

The capture module 812 can compare the capture speciation 814, as the original data capture specification, with the encountered data capture specification (based on observation of the user's interaction 204 with the application 108) that testers could compare to the original data capture specification. If the capture specification 814 is in a well-known format and the application 108 is using an analytics SDK with known characteristics, the capture module 812 can further verify whether the application 108 possesses the desired instrumentation. The capture module 812 can then generate the report 602 or modified data capture specification indicating where it found the desired instrumentation (potentially including mappings between desired instrumentation and likely corresponding location in the code), where it expected to find instrumentation but did not, and where it found instrumentation it did not expect. These disconnects can be the instrumentation error 816. In other words, the capture module 812 can identify the instrumentation error 816 for instrumentation omissions or additions in the application code 604.

Also for example, if the capture specification 814 is not specified or provided, the capture module 812 can generate the detected data capture specification (e.g., when the user does X the application logs Y) so that testers have a point of reference for the instrumented application. If the capture specification 814 is specified or provided, the capture module 812 can use it directly to generate the report 602 that lists the set of points that appear/do not appear to be instrumented correctly for the instrumentation error 816. For each instrumentation point the capture module 812 could also provide a pointer to the relevant section of the capture specification 814 and the actual detected specification for comparison purposes.

For illustrative purposes, the computing system 100 is described by operation of the first device 102 and the second device 106. It is understood that the first device 102 and the second device 106 can operate any of the modules and functions of the computing system 100.

The computing system 100 has been described with module functions or order as an example. The computing system 100 can partition the modules differently or order the modules differently. For example, the capture module 812 can be partition to separate modules. Also for example, the execution module 808 and the activation module 810 can be partially or wholly combined.

The modules described in this application can be hardware implementation or hardware accelerators or hardware circuitry in the first control unit 712 of FIG. 7 or in the second control unit 734 of FIG. 7. The modules can also be hardware implementation or hardware accelerators or hardware circuitry within the first device 102 or the second device 106 but outside of the first control unit 712 or the second control unit 734, respectively.

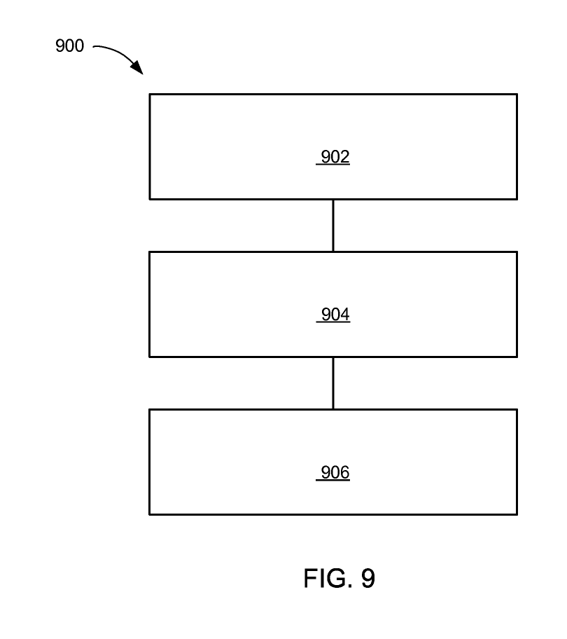

Referring now to FIG. 9, therein is shown a flow chart of a method 900 of operation of a computing system 100 in a further embodiment of the present invention. The method 900 includes: receiving an application code in a block 902; identifying an interface element in the application code with a control unit in a block 904; and inserting an augmentation code into the application code for modifying an attribute of the interface element in a block 906.

It has been discovered that the computing system 100 simplifies and improves verification of the application 108 because the execution module 808 runs the application code 604 in the computing system 100, the identification module 804 detects instrumentation points within the application 108 and the capture module 812 provides feedback about how the application 108 is instrumented during execution of the application 108. As examples, this feedback can include visually distinguishing interface controls that capture interactions (e.g., coloring buttons that capture clicks a different color than buttons that do not) and playing audio cues when the application 108 actually captures data (e.g., playing a particular tone with the application captures the user switching to a new view, while playing a different tone with the application captures the user interacting with an interface component within a view).

It has been discovered that the computing system 100 simplifies and improves verification of the augmentation code 605 while the capture module 812 can also detect, reformat, and present logged data to the tester. As an example, the instrumentation data 610 can be sent to the second device 106 of FIG. 1, such as a server, from the first device 102 of FIG. 7, such as a client device, over the communication path 104 of FIG. 7, such a network. The instrumentation data 610 communicated over the communication path 104 to the second device 106 is typically invisible to developers/testers, requiring extra work to inspect. The computing system 100 can perform that extra work automatically to detect, format, and display sent captured information. If the data is sent to a member of a known set of analytics providers the tool could additionally take advantage of known data formatting conventions for that provider by formatting the captured information before displaying it in order to make it even easier for testers to understand what information is actually being logged.

It has been discovered that the computing system 100 simplifies and improves verification of the application 108 because the capture module 812 can generate a data capture specification it believes the application 108 meets based on the a priori and runtime detected instrumentation, or if provided with the desired data capture specification, the capture specification 814, in a format the identification module 804 can parse and understand it could present the report 602 or a modified specification that conveys how and where it believes the application 108 does or does not meet the specification.

It has been discovered that the computing system 100 simplifies and improves verification of the application 108 because the capture module 812 can compare the capture speciation 820, as the original data capture specification, with the encountered data capture specification (based on observation of the user's interaction 204 with the application 108) that testers could compare to the original data capture specification. If the capture specification 814 is in a well-known format and the application 108 is using an analytics SDK with known characteristics, the capture module 812 can further verify whether the application 108 possesses the desired instrumentation. The capture module 812 can then generate the report 602 or modified data capture specification indicating where it found the desired instrumentation (potentially including mappings between desired instrumentation and likely corresponding location in the code), where it expected to find instrumentation but did not, and where it found instrumentation it did not expect. These disconnects can be the instrumentation error 816. In other words, the capture module 812 can identify the instrumentation error 816 for any instrumentation omissions or additions in the application code 604.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
an input module configured to receive an application code;
an identification module, coupled to the input module, configured to identify an interface element in the application code; and
an insertion module, coupled to the identification module, configured to insert an augmentation code into the application code for modifying an attribute of the interface element.

2. The system as claimed in claim 1 wherein the insertion module is configured to insert the augmentation code for modifying a visual appearance of the interface element.

3. The system as claimed in claim 1 wherein the insertion module is configured to insert the augmentation code for modifying an audio cue for the interface element.

4. The system as claimed in claim 1 further comprising:
an execution module, coupled to the insertion module, configured to execute the application code; and
an activation module, coupled to the execution module, configured to activate the attribute while the application code is being executed.

5. The system as claimed in claim 1 further comprising:
an execution module, coupled to the insertion module, configured to execute the application code and the augmentation code; and
a capture module, coupled to the execution module, configured to generate a report for an instrumentation coverage based on the execution of the application code.

6. The system as claimed in claim 1 further comprising:
an execution module, coupled to the insertion module, configured to execute the application code and the augmentation code; and
a capture module, coupled to the execution module, configured to generate a report for an instrumentation error based on the execution of the application code.

7. The system as claimed in claim 1 further comprising:
an execution module, coupled to the insertion module, configured to execute the application code and the augmentation code; and
a capture module, coupled to the execution module, configured to generate a report for a user's interaction with the interface element based on the execution of the application code.

8. The system as claimed in claim 1 wherein the identification module configured to identify the interface element based on a capture specification.

9. The system as claimed in claim 1 wherein the insertion module configured to insert the augmentation code before and after a handler for the interface element in the application code.

10. The system as claimed in claim 1 wherein the identification module configured to identify an analytic structure in the application code.

11. A method of operation of a computing system comprising:
receiving an application code;
identifying an interface element in the application code with a control unit; and
inserting an augmentation code into the application code for modifying an attribute of the interface element.

12. The method as claimed in claim 11 wherein inserting the augmentation code for modifying the attribute of the interface element includes inserting the augmentation code for modifying a visual appearance of the interface element.

13. The method as claimed in claim 11 wherein inserting the augmentation code for modifying the attribute of the interface element includes inserting the augmentation code for modifying an audio cue for the interface element.

14. The method as claimed in claim 11 further comprising:
executing the application code; and
wherein:
executing the application code includes executing the augmentation code for activating the attribute.

15. The method as claimed in claim 11 further comprising:
executing the application code and the augmentation code; and
generating a report for an instrumentation coverage based on the execution of the application code.

16. The method as claimed in claim 11 further comprising:
executing the application code and the augmentation code; and
generating a report for an instrumentation error based on the execution of the application code.

17. The method as claimed in claim 11 further comprising:
executing the application code and the augmentation code; and
generating a report for a user's interaction with the interface element based on the execution of the application code.

18. The method as claimed in claim 11 wherein identifying the interface element includes identifying the interface element based on a capture specification.

19. The method as claimed in claim 11 wherein inserting the augmentation code into the application code for modifying the attribute of the interface element includes inserting the augmentation code before and after a handler for the interface element in the application code.

20. The method as claimed in claim 11 wherein identifying the interface element in the application code includes identifying an analytic structure in the application code.
